(19) United States
(12) Patent Application Publication
(10) Pub. No.: US 2022/0326572 A1
(43) Pub. Date: Oct. 13, 2022

(54) DIRECT TYPE BACKLIGHT DISPLAY MODULE AND DISPLAY DEVICE

(71) Applicants: Guangzhou Shiyuan Electronics Co., Ltd., Guangzhou (CN); Guangzhou Shirui Electronics Co. Ltd., Guangzhou (CN)

(72) Inventor: Minxiang HOU, Guangzhou (CN)

(73) Assignees: Guangzhou Shiyuan Electronics Co., Ltd., Guangzhou (CN); Guangzhou Shirui Electronics Co. Ltd., Guangzhou (CN)

(21) Appl. No.: 16/314,002

(22) PCT Filed: Sep. 26, 2017
(86) PCT No.: PCT/CN2017/103431

§ 371 Date: Dec. 28, 2018

(30) Foreign Application Priority Data
May 12, 2017 (CN) 201710335386.5

(51) Int. Cl. G02F 1/1335; G02F 1/13357; G02F 1/1333

(52) U.S. Cl. CPC G02F 1/133607; G02F 1/133608; G02F 1/133605; G02F 1/13338

(57) ABSTRACT

The invention discloses a direct type backlight display module and a display device. The direct type backlight display module includes a backlight module and a liquid crystal panel corresponding to each other, and a main control circuit connected to the backlight module and the liquid crystal panel; the backlight module includes a back plate, a light emitting structure disposed on the back plate, a diffusion plate facing the light emitting structure, and an electromagnetic input module disposed between the light emitting structure and the liquid crystal panel; the electromagnetic input module includes an electromagnetic diaphragm disposed between the light emitting structure and the liquid crystal panel, and an electromagnetic control circuit electrically connected to the electromagnetic diaphragm; where the electromagnetic diaphragm has a transmittance greater than or equal to 50%, and the electromagnetic diaphragm is connected to the main control circuit through the electromagnetic control circuit. The technical solution provided by the invention may integrally integrate the electromagnetic touch input into the direct type backlight display module, and may also ensure that the liquid crystal screen has a good display effect.

### TECHNICAL FIELD

The present invention relates to the field of display device technologies, and in particular, to a direct type backlight display module and a display device.

### BACKGROUND

In conventional technology, liquid crystal display devices have become the mainstream display in the market due to low electromagnetic radiation, low power consumption, low heat generation, light and thin, etc. The LED (Light Emitting Diode) backlight displays are also widely used. At present, the LED backlight displays on the market are mainly divided into two types, according to the light incident mode, including an edge type and a direct type, where the edge type is to mount a string of LED lights as the backlight module around the liquid crystal screen, and the direct type is to mount the string of LED lights as the backlight module on the direct back side of the liquid crystal screen. The direct type backlight display is relatively inexpensive and more widely used.

In conventional technology, however, the direct backlight displays can only be used in a single function as a display. With the development of input technology and display technology, the combination of commonly used liquid crystal displays and touch apparatus has developed into a market trend. Moreover, there is increasing demand for high-quality touch input experience such as, for example, the pursuit of the original handwriting trajectory input effect. Thus, the electromagnetic screen technology has been widely used. The electromagnetic screen technology, however, usually requires the electromagnetic board to be mounted on the liquid crystal screen. For the edge type of LED backlight display, since the light source is disposed around the liquid crystal screen, when the electromagnetic board is mounted on the liquid crystal screen, it does not affect the effect of the light source on the liquid crystal screen; however, for the direct type LED backlight display, since the light source is disposed on the direct back side of the liquid crystal screen, the electromagnetic board mounted on the liquid crystal screen can severely affect the effect of the light source on the liquid crystal screen.

### SUMMARY

Based on the above, the present invention provides a direct type backlight display module and a display device, which may integrate an electromagnetic touch input into the direct type backlight display module, and may also ensure the high-quality display by the liquid crystal screen.

The technical solutions are as follows.

A direct type backlight display module includes a backlight module and a corresponding liquid crystal panel, and a main control circuit connected to the backlight module and the liquid crystal panel; where:

the backlight module includes a back plate, a light emitting structure disposed on the back plate, a diffusion plate facing the light emitting structure, and an electromagnetic input module disposed between the light emitting structure and the liquid crystal panel; and

the electromagnetic input module includes an electromagnetic diaphragm disposed between the light emitting structure and the liquid crystal panel, and an electromagnetic control circuit electrically connected to the electromagnetic diaphragm, where the electromagnetic diaphragm has a transmittance greater than or equal to 50%, and the electromagnetic diaphragm is connected to the main control circuit through the electromagnetic control circuit.

The following is a further description of the technical solutions.

Further, the electromagnetic diaphragm is disposed between the diffusion plate and the liquid crystal panel.

Further, an optical diaphragm assembly includes a reflective diaphragm, a brightness enhancement diaphragm, and a diffusion diaphragm which are sequentially stacked, where the reflective diaphragm corresponds to the diffusion plate, and where the diffusion diaphragm corresponds to the liquid crystal panel; and

the electromagnetic diaphragm is disposed between any two of the reflective diaphragms, the brightness enhancement diaphragm and the diffusion diaphragm; or the electromagnetic diaphragm is disposed between the reflective diaphragm and the diffusion plate; or the electromagnetic diaphragm is disposed between the diffusion diaphragm and the liquid crystal panel.

Further, the brightness enhancement diaphragm includes a prism diaphragm, a microlens and a reflective polarizing plate which are disposed in sequence; the prism diaphragm corresponds to the reflective diaphragm, and the reflective polarizing plate corresponds to the diffusion diaphragm; and

the electromagnetic diaphragm is disposed between any two of the prism diaphragms, the microlens and the reflective polarizing plate; or the electromagnetic diaphragm is disposed between the prism diaphragm and the reflective diaphragm; or the electromagnetic diaphragm is disposed between the reflective polarizing plate and the diffusion diaphragm.

Further, the electromagnetic diaphragm is disposed in the diffusion plate.

Further, the electromagnetic diaphragm, the liquid crystal panel and the optical diaphragm assembly have the identical shape and identical area, and edges of the electromagnetic diaphragm are aligned with both edges of the liquid crystal panel and edges of an optical diaphragm assembly.

Further, the area of the electromagnetic diaphragm is smaller than the area of the liquid crystal panel or the area of the optical diaphragm assembly, and the electromagnetic diaphragm is located at a certain position on the circumferential side of the liquid crystal panel or on the circumferential side of the optical diaphragm assembly.

Further, the backlight module further includes a touch input module disposed on the liquid crystal panel, the touch input module includes a touch input board disposed on the liquid crystal panel and a touch control circuit connected to the touch input board, and the touch control circuit is connected to the main control circuit.

Further, a middle frame structure is included, and the diffusion plate, the optical diaphragm assembly, the electromagnetic diaphragm and the liquid crystal panel are all fixed in the middle frame structure.

Further, the light emitting structure includes a direct type light bar disposed on the back plate and facing the diffusion plate, and a reflective plate surrounding a bottom side and a circumference side of the direct type light bar; the reflective plate corresponds to the diffusion plate.

In addition, the present invention also provides a display device including the direct type backlight display module as described above.

The invention has following beneficial effects: by combining the electromagnetic input technology and the direct type backlight display module, the integration of the electromagnetic input and the backlight display in the direct type backlight mode is achieved at a relatively low cost, and a multi-functional direct type backlight display module is realized; moreover, not only the liquid crystal display function but also the touch and trajectory simulation may be realized, and the real handwriting trajectory may also be simulated, thereby providing a good user experience.

### BRIEF DESCRIPTION OF DRAWINGS

FIG. 1 is a schematic structural diagram of a direct type backlight display device according to an embodiment of the present disclosure;

FIG. 2 is a schematic block diagram of a direct type backlight display device (with an electromagnetic diaphragm disposed between a diffusion plate and a liquid crystal panel) according to an embodiment of the present disclosure;

FIG. 3 is a schematic block diagram of a direct type backlight display device (with an electromagnetic diaphragm disposed between a light emitting structure and a diffusion plate) according to an embodiment of the present disclosure;

FIG. 4 is a schematic block diagram of a direct type backlight display device (with an electromagnetic diaphragm disposed in a diffusion plate) according to an embodiment of the present disclosure.

Description of the reference numerals:

100—backlight module, 110—back plate, 120—direct type light bar, 130—reflective plate, 140—diffusion plate, 150—optical diaphragm assembly, 200—electromagnetic input module, 210—electromagnetic diaphragm, 300—liquid crystal panel, 310—tempered glass, 400—main control circuit.

### DESCRIPTION OF EMBODIMENTS

The embodiments of the present invention will be described in detail below with reference to the accompanying drawings.

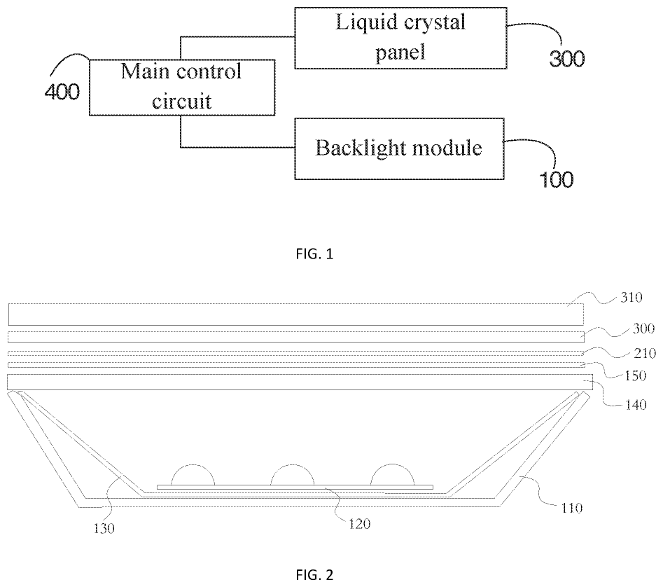

As shown in FIG. 1, an embodiment of the present invention provides a direct type backlight display module, including a backlight module 100 and a corresponding liquid crystal panel 300, and a main control circuit connected to the backlight module 100 and the liquid crystal panel 300. The main control circuit connected to the backlight module 100 and the liquid crystal panel 300 is to control the backlight module 100 and the liquid crystal panel 300, and to facilitate liquid crystal display or other functions.

Moreover, as shown in FIG. 2 to FIG. 4, the backlight module 100 includes a back plate 110, a light emitting structure disposed on the back plate 110, a diffusion plate 140 facing the light emitting structure, and an electromagnetic input module 200 disposed between the light emitting structure and the liquid crystal panel 300. The back plate 110 provides a mounting base for the entire backlight module 100, and the light emitting structure emits light to illuminate the liquid crystal panel 300. Moreover, by providing the electromagnetic input module 200 between the backlight module 100 and the liquid crystal panel 300, electromagnetic input may be realized on the direct type backlight display module. As such, the electromagnetic input technology may be combined with the direct type backlight display module, and an integration of the electromagnetic input and the backlight display in the direct type backlight mode may be achieved at a low cost, and a multi-functional direct type backlight display module may be realized. Moreover, the direct type backlight display module may implement not only the liquid crystal display function, but also the touch and trajectory simulation, and may also simulate the real handwriting trajectory, thereby providing a good user experience.

In addition, the light emitting structure includes a direct type light bar 120 disposed on the back plate 110 and facing the diffusion plate 140, and a reflective plate 130 surrounding a bottom side and a circumference side of the direct type light bar 120. The reflective plate 130 corresponds to the diffusion plate 140. The direct type light bar 120 emits light to the diffusion plate 140, and the diffusion plate 140 may change the beam angle of the light. After the light passes through the diffusion plate 140, the beam angle becomes 160-170 degrees. Moreover, the diffusion plate 140 may also haze an image and improve the uniformity of the image. In addition, the diffusion plate 140 also has a certain rigidity to facilitate supporting the optical diaphragm assembly 150. In addition, the reflective plate 130 may reflect part of the exposed light to the diffusion plate 140 to allow a secondary use of the light, thereby improving the utilization efficiency of the light and improving the brightness. Moreover, the reflective plate 130 is disposed as semi-surrounding on one side of the direct type light bar 120, and the light emitted by the direct type light bar 120 may be sufficiently reflected to further improve the light utilization efficiency.

In addition, the optical diaphragm assembly 150 includes a reflective diaphragm, a brightness enhancement diaphragm, and a diffusion diaphragm which are sequentially stacked. The reflective diaphragm corresponds to the diffusion plate 140, and the diffusion diaphragm corresponds to the electromagnetic input module 200. The optical diaphragm assembly 150 may further process the light for better light effects. The light is reflected multiple times by the reflective diaphragm to further improve the light utilization efficiency and enhance the brightness. In addition, the brightness of the light may be further enhanced by the brightness enhancement diaphragm to enhance the display intensity effect. In addition, the diffusion diaphragm may further haze an image, increase the viewing angle, and enhance the brightness. Moreover, the brightness enhancement diaphragm includes a prism diaphragm, a microlens or a reflective polarizing plate. The light is further processed by using the prism diaphragm, the microlens and the reflective polarizing plate, to further enhance the brightness and ensure the viewing angle.

In addition, the electromagnetic input module 200 includes an electromagnetic diaphragm 210 disposed between the light emitting structure and the liquid crystal panel 300, and an electromagnetic control circuit electrically connected to the electromagnetic diaphragm 210. The transmittance of the electromagnetic diaphragm is greater than or equal to 50%. The electromagnetic diaphragm 210 is connected to the main control circuit 400 through the electromagnetic control circuit. In addition, the electromagnetic input module 200 further includes an electromagnetic pen that works cooperatively with the electromagnetic diaphragm 210. By providing the transparent electromagnetic diaphragm 210, the direct type backlight display module may obtain an electromagnetic input capability, while ensuring good transmittance for the liquid crystal panel and avoiding impacts on the display image quality and brightness by the electromagnetic diaphragm 210, and having precise touch, further to ensure the best image performance and display effect by the screen. The electromagnetic pen may be used for inputting on the liquid crystal panel 300, and the electromagnetic diaphragm 210 disposed on the liquid crystal panel 300 may sense the writing input by the electromagnetic pen, thereby transmitting a precise handwriting mode and simulating the effect of the thickness with respect to the diameter of a pen when writing with a pen in real, and getting a good original handwriting trajectory input experience. Moreover, the electromagnetic control circuit may control the electromagnetic diaphragm 210, conveniently enabling, disabling, and adjusting the electromagnetic input function.

Moreover, in some embodiments, as shown in FIG. 2, the electromagnetic diaphragm 210 may be disposed between the diffusion plate 140 and the liquid crystal panel 300. Moreover, further, in some embodiments, the electromagnetic diaphragm 210 may be disposed between any two of the reflective diaphragms, the brightness enhancement diaphragm and the diffusion diaphragm. That is, the electromagnetic diaphragm 210 may be disposed between the reflective diaphragm and the brightness enhancement diaphragm, or may be disposed between the brightness enhancement diaphragm and the diffusion diaphragm. In addition, in other embodiments, the electromagnetic diaphragm 210 may be disposed between the reflective diaphragm and the diffusion plate 140 or between the diffusion diaphragm and the liquid crystal panel 300. When the electromagnetic diaphragm 210 is disposed at these positions, a good electromagnetic input effect may be achieved without affecting the display function of the liquid crystal panel.

In addition, in some embodiments, the electromagnetic diaphragm 210, the liquid crystal panel 300 and the optical diaphragm assembly 150 have the identical shape and identical area, and edges of the electromagnetic diaphragm 210 are aligned with both edges of the liquid crystal panel 300 and edges of the optical diaphragm assembly 150. That is, the electromagnetic diaphragm 210 is completely aligned with the liquid crystal panel 300 and the optical diaphragm assembly 150, and the electromagnetic diaphragm 210 completely covers the corresponding position of the liquid crystal panel 300, so that all positions corresponding to the entire liquid crystal panel 300 may receive the effect of electromagnetic input. In addition, in other embodiments, the area of the electromagnetic diaphragm 210 is smaller than the area of the liquid crystal panel 300 or the area of the optical diaphragm assembly 150, and the electromagnetic diaphragm 210 is located somewhere on the circumference side of the liquid crystal panel 300 or on the circumference side of the optical diaphragm assembly 150. That is, the electromagnetic diaphragm 210 is not completely aligned with the liquid crystal panel 300 and the optical diaphragm assembly 150, but only corresponds to a certain portion of the liquid crystal panel 300, and only the corresponding portion has an electromagnetic input effect to satisfy different use needs.

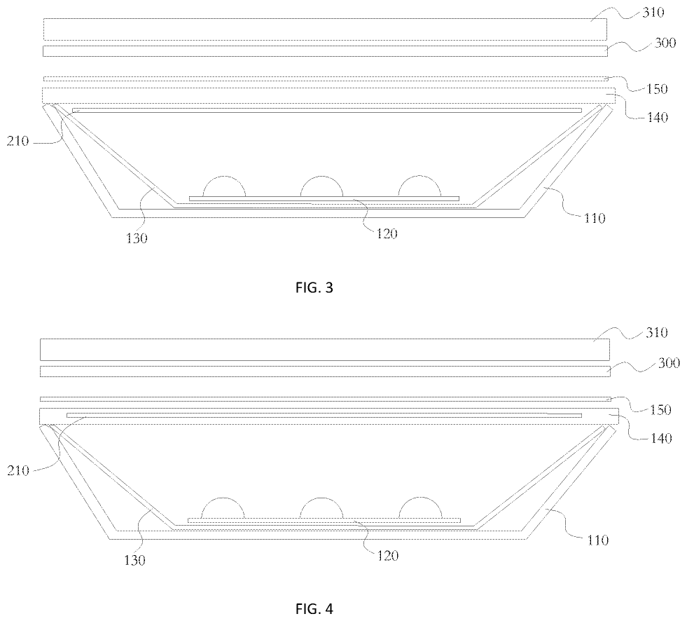

In addition, in other embodiments, as shown in FIG. 3, the electromagnetic diaphragm 200 may also be disposed between the light emitting structure and the diffusion plate 140. That is, the electromagnetic diaphragm 200 may be kept at a certain distance from the diffusion plate 140, or the electromagnetic diaphragm 200 may be attached to the diffusion plate 140. When the electromagnetic diaphragm 200 is disposed between the light emitting structure and the diffusion plate 140, an electromagnetic input function may also be realized. Moreover, the distance between the electromagnetic diaphragm 200 and the light emitting structure is greater than or equal to 10 cm. Specifically, the distance between the electromagnetic diaphragm 200 and the direct type light bar 120 is greater than or equal to 10 cm. Because the electromagnetic diaphragm 200 is provided with an electromagnetic coil, and an eddy current is generated in the electromagnetic coil, if the distance between the direct type light bar 120 and the electromagnetic diaphragm is less than 10 cm, the eddy current in the electromagnetic coil is affected, and the normal operation of the electromagnetic diaphragm 200 is affected. In addition, a silicon steel plate may be disposed between the electromagnetic diaphragm 200 and the direct type light bar 120 to isolate the impact of the direct type light bar 120 on the electromagnetic diaphragm 200.

Moreover, in some embodiments, the electromagnetic diaphragm 210 and the diffusion plate 140 have the identical shape and identical area, and edges of the electromagnetic diaphragm 210 are aligned with edges of the diffusion plate 140. That is, the electromagnetic diaphragm 210 is completely aligned with the diffusion plate 140, and the electromagnetic diaphragm 210 completely covers the diffusion plate 140, so that all positions corresponding to the entire diffusion plate 140 may receive effects of electromagnetic input s. Further, in other embodiments, the area of the electromagnetic diaphragm 210 is smaller than the area of the diffusion plate 140, and the electromagnetic diaphragm 210 is located at a certain position on the circumferential side of the diffusion plate 140. That is, the electromagnetic diaphragm 210 is not completely aligned with the diffusion plate 140, but only locates at a certain portion of the diffusion plate 140, and only the corresponding portion has an electromagnetic input effect to satisfy different use needs.

In addition, in other embodiments, as shown in FIG. 4, the electromagnetic diaphragm 200 may also be directly disposed in the diffusion plate 140, and the function of electromagnetic input may also be realized.

In addition, the direct type backlight display module further includes a touch input module disposed on the liquid crystal panel 300, and the touch input module includes a touch input board disposed on the liquid crystal panel 300 (air side), and a touch control circuit connected to the touch input board, and the touch control circuit is connected to the main control circuit. The touch input board may be controlled by the touch control circuit to enable, disable and adjust the touch input function, so that the direct type backlight display module has a common touch input function. Moreover, the touch input board of the touch input module also has good transmittance, and does not affect the display effect of the direct type backlight display module. In addition, the conventional touch input module does not need to react differently to different strengths of the input pressure, and may be operated by either the hand or the dedicated pen. The electromagnetic input module may sense the strength of the input pressure, and may simulate real writing trajectory. But a dedicated electromagnetic pen is required to make a professional presentation. The touch input module as well as the electromagnetic input module may be disposed on both sides of the liquid crystal panel 300 simultaneously, or may be singularly disposed on the air side surface of the liquid crystal panel 300. In such way, it may simultaneously satisfy different usage needs.

Moreover, the touch input module may be configured as a capacitive input module or an infrared input module. When the touch input module is configured as a capacitive input module, the capacitive input module includes a capacitive input board disposed on the liquid crystal panel 300 (air side), and a capacitance control circuit connected to the capacitive input board. The capacitance control circuit is connected to the main control circuit. When the touch input module is configured as an infrared input module, the infrared input module includes an infrared sensor board disposed on the liquid crystal panel 300 (air side), and an infrared control circuit connected to the infrared sensor board. The infrared control circuit is connected to the main control circuit.

In addition, the direct type backlight display module further includes a tempered glass 310 disposed on a surface of the touch input board. The tempered glass 310 may protect the touch input board and the liquid crystal panel 300. In addition, when a capacitor input structure is not available, the tempered glass 310 may be directly disposed on the air side surface of the liquid crystal panel 300 to directly protect the liquid crystal panel 300.

In addition, the direct type backlight display module further includes a middle frame structure, and the diffusion plate, the optical diaphragm assembly, the electromagnetic diaphragm and the liquid crystal panel are all fixed therein. With the middle frame structure, a mounting base and a protective housing may be provided for the diffusion plate 140, the optical diaphragm assembly 150, the electromagnetic diaphragm 210 and the liquid crystal panel 300, so as to make their structures firmer and more reliable. In addition, the main control circuit, the electromagnetic control circuit and the touch control circuit may also be disposed on the middle frame structure.

In addition, the present invention also provides a display device including the direct type backlight display module as described above. The direct type backlight display module and the display device provided by the invention achieve the integration of the electromagnetic input and the backlight display in the direct type backlight mode at a low cost by setting the electromagnetic input technology and the direct type backlight display module as a whole, and achieve the multi-functional direct type backlight display module; moreover, the invention may realize not only the liquid crystal display function but also the touch and trajectory imitation, and also simulate the real handwriting trajectory, thereby providing a good user experience.

The technical features of the above-described embodiments may be combined in any combination. To make the description concise, all possible combinations of the technical features in the embodiments are not described. However, as long as there is no contradiction in the combination of these technical features, it should be considered as the scope of this description.

The above-described embodiments are merely illustrative of several embodiments of the present invention, and the description thereof is more specific and detailed, but is not to be construed as limiting the scope of the invention. It should be noted that a number of variations and modifications may be made by those skilled in the art without departing from the spirit and scope of the invention. Therefore, the scope of the invention should be determined by the appended claims.

1. A direct type backlight display module, comprising:
a backlight module and a corresponding liquid crystal panel; and
a main control circuit connected to the backlight module and the liquid crystal panel, wherein:
the backlight module comprises a back plate, a light emitting structure disposed on the back plate, a diffusion plate facing the light emitting structure, and an electromagnetic input module disposed between the light emitting structure and the liquid crystal panel; and
the electromagnetic input module comprises an electromagnetic diaphragm disposed between the light emitting structure and the liquid crystal panel, and an electromagnetic control circuit electrically connected to the electromagnetic diaphragm, wherein the electromagnetic diaphragm has a transmittance greater than or equal to 50%, and the electromagnetic diaphragm is connected to the main control circuit through the electromagnetic control circuit.

2. The direct type backlight display module according to claim 1, wherein the electromagnetic diaphragm is disposed between the diffusion plate and the liquid crystal panel.

3. The direct type backlight display module according to claim 2, wherein an optical diaphragm assembly comprises a reflective diaphragm, a brightness enhancement diaphragm and a diffusion diaphragm which are sequentially stacked, the reflective diaphragm corresponds to the diffusion plate, and the diffusion diaphragm corresponds to the liquid crystal panel; and
the electromagnetic diaphragm is disposed between any two of the reflective diaphragms, the brightness enhancement diaphragm and the diffusion diaphragm; or the electromagnetic diaphragm is disposed between the reflective diaphragm and the diffusion plate; or the electromagnetic diaphragm is disposed between the diffusion diaphragm and the liquid crystal panel.

4. The direct type backlight display module according to claim 3, wherein the brightness enhancement diaphragm comprises a prism diaphragm, a microlens and a reflective polarizing plate which are disposed in sequence; the prism diaphragm corresponds to the reflective diaphragm, and the reflective polarizing plate corresponds to the diffusion diaphragm; and
the electromagnetic diaphragm is disposed between any two of the prism diaphragms, the microlens and the reflective polarizing plate; or the electromagnetic diaphragm is disposed between the prism diaphragm and the reflective diaphragm; or the electromagnetic diaphragm is disposed between the reflective polarizing plate and the diffusion diaphragm.

5. The direct type backlight display module according to claim 1, wherein the electromagnetic diaphragm is disposed in the diffusion plate.

6. The direct type backlight display module according to claim 1, wherein the electromagnetic diaphragm, the liquid crystal panel and the optical diaphragm assembly have identical shape and identical area, and edges of the electromagnetic diaphragm are aligned with both edges of the liquid crystal panel and edges of an optical diaphragm assembly.

7. The direct type backlight display module according to claim 1, wherein an area of the electromagnetic diaphragm is smaller than an area of the liquid crystal panel or an area of the optical diaphragm assembly, and the electromagnetic diaphragm is located at a position on the circumferential side of the liquid crystal panel or on the circumferential side of an optical diaphragm assembly.

8. The direct type backlight display module according to claim 1, further comprising a touch input module disposed on the liquid crystal panel, wherein the touch input module comprises a touch input board disposed on the liquid crystal panel and a touch control circuit connected to the touch input board, and the touch control circuit is connected to the main control circuit.

9. The direct type backlight display module according to claim 1 to 5, wherein the light emitting structure comprises a direct type light bar disposed on the back plate and directly facing the diffusion plate, and a reflective plate surrounding a bottom side and a circumference side of the direct type light bar, wherein the reflective plate corresponds to the diffusion plate.

10. A display device, comprising the direct type backlight display module according to claim 1.
